(19) United States
(12) Patent Application Publication
(10) Pub. No.: US 2006/0242809 A1
(43) Pub. Date: Nov. 2, 2006

(54) DEVICE FOR ADJUSTING A SPRING SHOCK ABSORBER LEG

(76) Inventor: Horst KLANN, Villingen-Schwenningen (DE)

Correspondence Address: MCGLEW & TUTTLE, PC, P.O. BOX 9227, SCARBOROUGH STATION, SCARBOROUGH, NY, 10510-9227, US

(21) Appl. No.: 11/279,946

(22) Filed: Apr. 17, 2006

(30) Foreign Application Priority Data
Apr. 19, 2005 (DE) 20 2005 006 200.6

(51) Int. Cl. B23P 19/04

(52) U.S. Cl. 29/227

(57) ABSTRACT

A device for adjusting a spring shock absorber leg (38) has an upper spring plate (2) and a lower spring plate (40) arranged in an axially fixed manner at a shock absorber pipe (39) of the spring shock absorber leg (38), between which a coil spring (41) is accommodated under pretension during operation. The shock absorber pipe (39) has, on its lower end, a bearing eye (37) running transversely to the shock absorber pipe (39). In order to be able to provide, without any doubt, a to-be-selected angular alignment of a spring plate to its bearing eye, an adjusting plate (1) is provided, which can be caused to mesh in a fixed manner with the upper spring plate in a predetermined angular position. The adjusting plate (1), together with the upper spring plate (2), can be aligned in relation to the lower bearing eye (37) of the shock absorber pipe (39) by means of an adjusting device (35).

### CROSS REFERENCE TO RELATED APPLICATIONS

This application claims the benefit of priority under 35 U.S.C. § 119 of German Patent Application DE 20 2005 006 200 filed Apr. 19, 2005, the entire contents of which are incorporated herein by reference.

### FIELD OF THE INVENTION

The present invention pertains to a device for adjusting a spring shock absorber leg, which has an upper spring plate and a lower spring plate arranged in an axially fixed manner at a shock absorber pipe of the spring shock absorber leg, between which a coil spring is accommodated under pretension during operation, wherein the shock absorber pipe has, on its lower end, a bearing eye running transversely to the shock absorber pipe.

### BACKGROUND OF THE INVENTION

Spring shock absorber legs are sufficiently known from the state of the art. These are used in motor vehicles for supporting the axle body and have an upper spring plate which is usually screwed to the body of the motor vehicle in a predetermined angular position during operation. To this end, this upper spring plate may be provided either with threaded holes or threaded pins, by means of which the spring plate can be screwed to the body in the corresponding position. Furthermore, such spring shock absorber legs are provided with a “lower” spring plate which is arranged in an axially fixed manner at a shock absorber pipe of the spring shock absorber leg at an axial distance to the upper spring plate. This lower spring plate may be fastened at the shock absorber pipe in a detachable manner as well and be designed as rotatable in relation to the shock absorber pipe. A coil spring, by means of which the motor vehicle is supported in a springable manner, is accommodated under pretension between these two spring plates during the operation of the motor vehicle.

Furthermore, a bearing eye or a mounting yoke, which is arranged in a fixed manner at the shock absorber pipe running essentially transversely to the central longitudinal axis of this shock absorber pipe, is provided in some designs of a spring shock absorber leg in the lower end area of the shock absorber pipe. Via this bearing eye, the spring shock absorber leg can be caused to mesh with a corresponding mount of an axle body. The spring shock absorber leg is mounted pivotably on the axle body via the bearing eye. A bearing yoke with two bearing clips, which are provided with bearing holes running coaxially towards one another, via which the spring shock absorber leg can be brought pivotably into connection with the axle body, may also be provided on the lower end of the spring shock absorber leg.

During the mounting of the coil spring between the two spring plates, for example, with the aid of a spring vice, the upper spring plate is brought into a predetermined angular position opposite the lower bearing eye, in order to be able to align the upper spring plate on the mounting holes of the body, on the one hand, during the later installation of the spring shock absorber leg in the motor vehicle, and, on the other hand, at the same time to correctly align the bearing eye on the mounting holes of the axle body. This means that the upper spring plate is to be aligned as correctly as possible in relation to its angular position already during the mounting of the spring opposite the bearing eye of the spring shock absorber leg.

To this end, for example, a device is known from the state of the art (DE 41 21 938 A1), which is provided with a clamping device, in which the bearing eye of the spring shock absorber leg can be accommodated in a fixed manner. This clamping device is designed similar to the design of a vice and has a holding plate, which carries the actual clamping device for the bearing eye. This holding plate is, furthermore, provided with a guide pipe, which runs approximately parallel to the spring shock absorber leg during the use of the device and extends approximately over half the length of the spring shock absorber leg. This guide pipe is connected to the support plate in a fixed manner. An angle dial, which is likewise connected to the guide pipe in a fixed manner, is provided in the upper end area of this guide pipe. A telescopic rod, which is connected to a dial pointer in a manner adapted to rotate in unison, is, in turn, arranged axially adjustably and rotatably in the guide pipe. This dial pointer is likewise arranged in the upper end area of the guide pipe and may lie loosely on the graduated dial, for example. If the telescopic rod is rotated, this dial pointer is also rotated, so that, based on the graduated dial, the relative angular position of the telescopic rod to the guide pipe and thus also to the bearing eye of the spring shock absorber leg clamped in the clamping device can be read. In order to be able to align the upper spring plate in a predetermined angular position in relation to the clamped bearing eye of the spring shock absorber leg, the telescopic rod protrudes axially out of the guide pipe approximately up into the upper end area of the spring shock absorber leg and has, on its upper end, a bearing head, which is used to accommodate a multi-adjustable rod design. This rod design is provided with a so-called aligning ruler in the form of a flat bar steel, which can be caused to mesh with the upper spring plate with its mounting elements in a fixed manner. The mounting elements of the spring plate are those elements, which are used for the fixed mounting of the spring plate on the body of the vehicle.

This prior-art device can be adjusted to various angular positions of upper spring plates to their lower bearing eyes for various spring shock absorber legs, and the telescopic rod is accommodated in an axially adjustable manner in the guide pipe, so that the telescopic rod can follow the adjusting movement of the coil spring to be arranged between the two spring plates occurring during the clamping procedure or releasing procedure.

It has now been pointed out that this device for aligning spring plates of different spring shock absorber legs must either undergo an expensive retrofit, which pertains to its rod design, or that the installer must know and correspondingly read or adjust on the graduated dial the associated aligning angle for correspondingly selected spring shock absorber legs. This has the drawback that mistakes may occur under the circumstances, such that an adjustment made for a certain spring shock absorber leg is incorrect and this may subsequently be installed incorrectly in a motor vehicle.

### SUMMARY OF THE INVENTION

Accordingly, the basic object of the present invention is to provide a device, by means of which a to-be-selected angular alignment of a spring plate of a spring shock absorber leg with its bearing eye can be carried out without any doubt.

The object is accomplished according to the present invention in that an adjusting plate is provided, which can be caused to mesh with the upper spring plate in a predetermined angular position in a fixed manner, and that the adjusting plate, together with the upper spring plate, can be aligned via an adjusting device in relation to the lower bearing eye of the shock absorber pipe.

Faulty adjustments are reliably ruled out by means of the design according to the present invention with its adjusting plate. The adjusting plate can be used with an adjusting device, on the one hand. The device described in the specification introduction from DE 41 21 938 A1, for example, may be used here as the adjusting device. By means of the corresponding embodiment and arrangement of the adjusting plate on the upper spring plate, for example, when using such an adjusting device according to the state of the art, this adjusting device can always be adjusted to an adjusting angle of 0° with its dial pointer in relation to the angle dial of the graduated dial, such that mistakes can unambiguously no longer occur here. This means that the adjusting plate can be coupled with the adjusting device in such a way that, when adjusting the dial pointer to an angular position of 0°, the upper spring plate, which is coupled with the adjusting plate, automatically assumes the correct angular position to the lower bearing eye of the spring shock absorber leg. This correct angular position is thus determined by means of the predetermined angular position of the spring plate to the adjusting plate, and knowledge about the angular position of the spring plate to the bearing eye actually to be adjusted is not necessary.

Thus, according to another aspect of the invention provisions may be made for the adjusting plate to be provided with a plurality of through holes, via which the spring plate can be mounted in a fixed manner in the predetermined angular position on the adjusting plate. By means of this design, the upper spring plate can be coupled precisely with the adjusting plate in an extremely simple manner.

According to another aspect of the invention, provisions may be made for the adjusting plate to have a plurality of groups of through holes, via which the spring plate can be selectively mounted on the adjusting plate in various angular positions and for the through holes to be characterized in groups differently for the various application purposes. The spring shock absorber legs are frequently installed in a motor vehicle in a mirror symmetrical manner on the left and right sides of the vehicle. This means that the angular position of the upper spring plate to the lower bearing eye of the spring shock absorber leg, for example, in relation to the central longitudinal axis of the vehicle, is also selected in a mirror symmetrical manner. By means of this embodiment, such a mirror-symmetrical angular alignment of the upper spring plate can be unambiguously adjusted in a simple manner with a single adjusting plate.

According to another aspect of the invention, provisions may be made for the adjusting plate to have a holding section, via which the adjusting plate can be coupled to the adjusting device. By means of this embodiment, the adjusting plate can be coupled to the adjusting device in an unambiguous position regardless of its coupling with the spring plate.

According to another aspect of the invention, provisions may be made for the adjusting device to have a tensioning means for the fixed clamping of the bearing eye of the spring shock absorber leg and for the tensioning means to be provided with a holding plate, on which is arranged in a fixed manner a guide pipe running, during use, parallel to the spring shock absorber leg clamped with its bearing leg in the tensioning means, in which [guide pipe] a telescopic rod is accommodated in an axially displaceable manner and rotatable in relation to the holding plate, and for an aligning element, to which the adjusting plate is fastened in a detachable manner with its holding section, is provided in the upper end area of the telescopic rod. In a first embodiment, the telescopic rod may mesh with the guide pipe in a manner adapted to rotate in unison, so that the adjusting plate, after coupling to this adjusting device, always assumes an unambiguous position to the bearing eye of the spring shock absorber leg clamped in the tensioning means, as a result of which at the same time an unambiguous angular alignment of the upper spring plate coupled to the adjusting plate is achieved.

On the other hand, provisions may be made according to another aspect of the invention for a graduated dial with an angle dial to be provided on the upper end of the guide pipe, which dial is connected in a fixed manner to the guide pipe, and for a dial pointer connected to the telescopic rod in a manner adapted to rotate in unison to be arranged in the area of the angle dial. By means of this embodiment, the adjusting device can be used, on the one hand, in the conventional manner as known from the state of the art, and, on the other hand, also selectively with the adjusting plate according to the present invention, whereby, as already mentioned above, the dial pointer can always be adjusted to the same angular position, preferably the angular position 0° of the angle dial, e.g., for a correct angular alignment of the spring plate.

For this variable use of the adjusting device and for a simple coupling of the adjusting plate to the adjusting device, provisions may be made according to another aspect of the invention for the aligning element to have a first cylindrical guide bar, via which the aligning element is mounted axially displaceably and rotatably in a guide head, which is arranged in a fixed manner in an end area of a second guide bar, and for the second guide bar to run at right angles to the first guide bar, and for the second guide bar to be accommodated axially adjustably and rotatably in another guide head on the upper end of the telescopic rod, and for the other guide head to be mounted pivotably via a bearing head on the upper end of the telescopic rod at right angles to the central longitudinal axis of the telescopic rod. By means of this embodiment, the adjusting plate can be used for spring plates, whose surface, in the mounted state, does not run at right angles to the central longitudinal axis of the spring shock absorber leg. Multiple pivotability of the guide bars is provided for such an adaptation to the slope of a spring plate.

According to another aspect of the invention, provisions may be made, furthermore, for the adjusting device to be formed from two guide pipes, two guide rods and an aligning rod, and for the guide pipes to be arranged in a fixed manner in the area of two holding lugs of the adjusting plate, and for the aligning rod to be able to mesh with the bearing eye of the spring shock absorber leg with small clearance and to be able to be brought into connection with the guide pipes of the adjusting plate via the two guide rods in a manner adapted to rotate in unison and in an axially adjustable manner. This embodiment of the adjusting device is characterized by an extremely simple structure and by an extremely simple handling. When such an adjusting device is used, it is especially not necessary to clamp the bearing eye in a special clamping device, since the correct angular alignment of the spring plate with the bearing eye takes place by means of the aligning rod meshing with the bearing eye by means of the two guide rods and the adjusting plate.

Some exemplary embodiments of the present invention will be explained in detail below based on the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective exploded view of a first exemplary embodiment of an adjusting plate together with coupling means, via which this adjusting plate can be coupled to an adjusting device;

FIG. 2 is a basic perspective view of an upper spring plate of a spring shock absorber leg that can be coupled to the adjusting plate of FIG. 1;

FIG. 3 is a perspective view of the adjusting plate of FIG. 1 with the upper spring plate of FIG. 2 in use on a spring shock absorber leg together with an adjusting device;

FIG. 4 is a perspective exploded view of a second exemplary embodiment of an adjusting plate together with the elements of an adjusting device;

FIG. 5 is the device of FIG. 4 in use on a spring shock absorber leg together with the spring plate of FIG. 2 as well as an additional tensioning means, in which the shock absorber pipe of the spring shock absorber leg is clamped.

### DESCRIPTION OF THE PREFERRED EMBODIMENTS

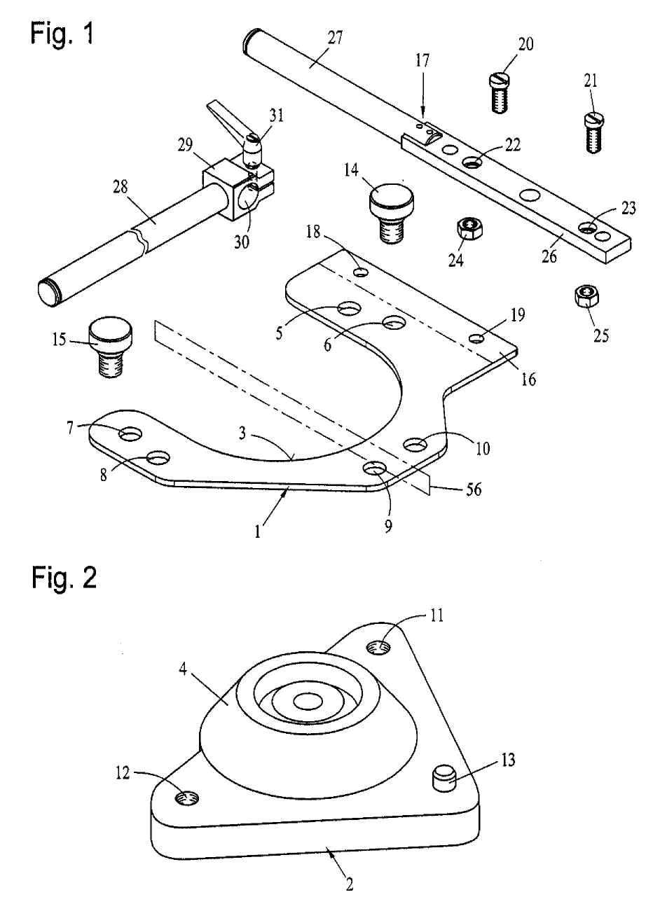

Referring to the drawings in particular, FIG. 1 shows a perspective view of a first exemplary embodiment of an adjusting plate 1, which can be caused to mesh with a spring plate 2 of FIG. 2 in a predetermined angular position.

In the present exemplary embodiment, the adjusting plate 1 has an essentially U-shaped recess 3, into which extends an axially upwards projecting mounting lug 4 of the spring plate 2 in the mounted state. As an alternative to this embodiment, the adjusting plate 1 may also have a ring-shaped design. For the fixed coupling of the adjusting plate 1 to the spring plate 2 from FIG. 2, the adjusting plate 1 has a plurality of through holes 5, 6, 7, 8, 9 and 10. The arrangement of these through holes 5 through 10 is selected such that the adjusting plate 1 can be placed on the spring plate 2, for example, in a predetermined angular position with its through holes 5, 8 and 10 in an exact position on the spring plate 2.

In the exemplary embodiment schematically shown in FIG. 2, the spring plate 2 has two threaded holes 11 and 12, on which the adjusting plate 1 can be aligned, for example, with its two through holes 5 and 8. In the normal operation of the spring plate 2, the threaded holes 11 and 12 are used for fastening the spring plate 2 to a body of a motor vehicle. Furthermore, it can be recognized from FIG. 2 that the spring plate 2 has an axially upwards projecting centering pin 13, which is used as a positioning aid for mounting on the motor vehicle body. With this centering pin 13, the adjusting plate 1 can be caused to mesh, for example, with the through hole 10 in a positive-locking manner.

Thus, it is clear that the adjusting plate 1 can be placed on the spring plate 2, for example, with its through holes 5, 8 and 10 in a predetermined angular position. For securing the position of the adjusting plate 1 on the spring plate 2, two fastening screws 14 and 15, which can be inserted through the through holes 5 and 8 and can be caused to mesh with the two threaded holes 11 and 12 of the spring plate 2, are provided in the present exemplary embodiment. The adjusting plate can thus be placed in a fixed manner on the spring plate 2 in a predetermined angular position, which is defined by the through holes 5, 8 and 10, in a simple manner.

Since such spring plates 2 are used on a vehicle both on the left and on the right spring shock absorber legs, it may be necessary to install the spring plate 2 in the vehicle on the right side of the vehicle in a different angular position than on the left side of the vehicle. In order to make possible this alternate installation with the same adjusting plate, the other through holes 6, 7 and 9 are provided.

If, for example, the spring plate 1 is aligned on the right side with the aid of the through holes 5, 8 and 10 in relation to the adjusting plate 1, then the through holes 6, 7 and 9 are used for the installation on the left side of the vehicle, such that the adjusting plate can be caused to mesh with the spring plate 2 in a second, predefined angular position. To this end, these through holes 5, 8, 10 and 6, 7, 9 may be provided with corresponding marks “L” and “R,” respectively (not explicitly shown in the drawings), so that it is apparent to the installer which of the through holes 5 through 10 are to be selected for the left-sided or right-sided mounting.

Furthermore, the adjusting plate 1 of the exemplary embodiment from FIG. 1 has a flat holding section 16, on which an aligning element 17 can be mounted in a fixed manner. For this fixed mounting, the holding section 16 in turn has two through holes 18 and 19. Two fastening screws 20 and 21, which can be screwed through the corresponding threaded section 22 and 23 of the aligning element 17 and which can be inserted through the through holes 18 and 19 of the holding section 16, are provided for this purpose in the present exemplary embodiment. By means of two fastening nuts 24 and 25, the aligning element 17 can thus be fastened to the holding section 16 of the adjusting plate 1 in a fixed manner and in an exact position by means of the two fastening screws 20 and 21.

As is also apparent from FIG. 1, the aligning element 17 forms, in the area of its through threaded section 22 and 23, a flat bar steel 26, whose length corresponds approximately to the length of the holding section 16, such that this flat bar steel 26 can be placed flat on the holding section 16 and be screwed to same.

A cylindrical guide bar 27, which, for angular alignment of the adjusting plate 1 via a second guide bar 28, can be caused to displaceably mesh lengthwise with a guide head 29 of the second guide bar 28, is fastened to this flat bar steel 26 in axial extension rearwards. For mounting the guide bar 27, the guide head 29 has a corresponding through hole 30, which is embodied as a clamping element and can be braced by means of a tightening screw 31, such that the guide bar 27 can be fixed in a fixed manner in this through hole in a preset position.

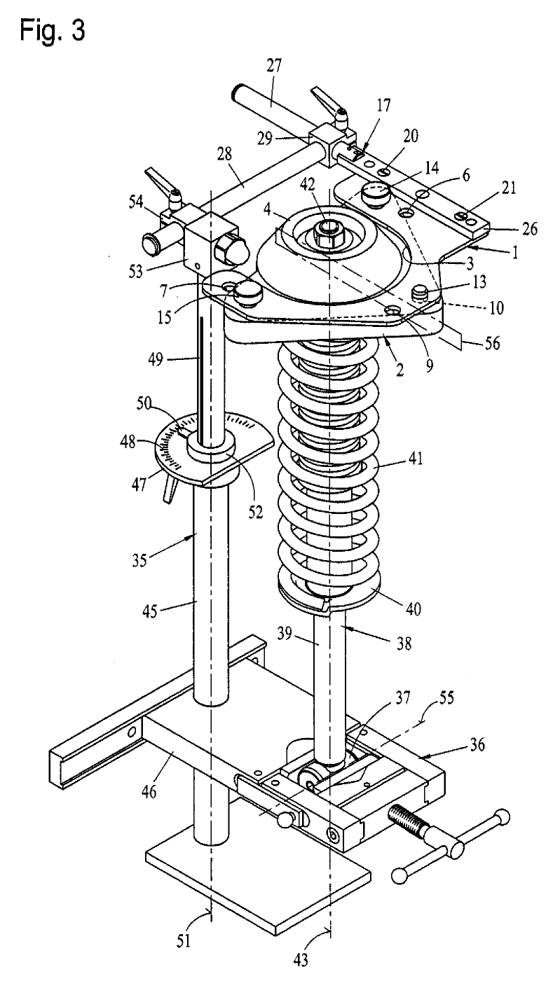

The two guide bars 27 and 28 or the aligning element 17 and the guide bar 28 may be part of an adjusting device 35, as this is apparent, for example, from FIG. 3.

In the present exemplary embodiment, this adjusting device 35 consists of a tensioning means 36, which is used for mounting a lower bearing eye 37 of a spring shock absorber leg 38. As is apparent from FIG. 3, this spring shock absorber leg 38 forms a shock absorber pipe 39 running vertically starting from the bearing eye 37 in the clamped state in FIG. 3, on which a lower spring plate 40 is arranged in an axially fixed manner in the present exemplary embodiment. A coil spring 41, which meshes with the upper spring plate 2 of FIG. 2 with its upper end, is placed on this lower spring plate 40.

In the completely mounted state of the coil spring 41 between the lower spring plate 40 and the upper spring plate 2 in FIG. 3, the coil spring is under axial pretension in the normal state of operation. For mounting the upper spring plate 2, the coil spring 41 is first pretensioned by means of a spring vice, which is sufficiently known from the state of the art, and is shortened in its axial length to the extent that the upper spring plate 2 can be placed onto the upper end of the coil spring 41, on the one hand, and at the same time can be caused to mesh with a piston rod 42 of a shock absorber element (not visible in the drawing) arranged within the shock absorber pipe 39. In order now to be able to correctly align this spring plate 2 in its angular position in relation to the bearing eye 37, the adjusting plate 1 is provided.

It can be recognized that the adjusting plate 1 meshes with the centering pin 13 of the upper spring plate 2 with its through hole 10. Furthermore, the adjusting plate 1 is screwed in a fixed manner to the spring plate 2 via the two fastening screws 14 and 15. It is clear that because of this connection of the adjusting plate 1 to the spring plate 2, the adjusting plate 1 has an exactly defined angular position to the spring plate 2. It is also recognizable from FIG. 3 that the axially upwards projecting mounting lug 4 of the spring plate 2 is accommodated by the recess 3 of the adjusting plate 1.

The aligning element 17 is mounted in a fixed manner on the adjusting plate 1 with its flat bar steel 26 by means of the two fastening screws 20 and 21 and, with its guide bar 27, meshes with the guide head 29 of the second guide bar 28.

It is also apparent from FIG. 3 that the adjusting device 35 is provided with a guide pipe 45 which runs essentially parallel to the spring shock absorber leg 38 and which is arranged in a fixed manner on a holding plate 46 of the tensioning means 36. A graduated dial 47, which has an angle dial 48 extending approximately over 180°, is arranged in a fixed manner at the upper end of this guide pipe 45 in the present exemplary embodiment. An axially adjustable telescopic rod 49, which is accommodated rotatably in the guide pipe 45 in the present exemplary embodiment and is axially adjustable in relation to the guide pipe 45 and thus also in relation to the spring shock absorber leg 38, is inserted into this guide pipe 45.

Furthermore, on the graduated dial 47 is provided a dial pointer 50, which is also adjusted with the telescopic rod 49 in case of its rotation about its central longitudinal axis 51. In this case, this dial pointer 50 is mounted in an axially fixed manner and rotatably in the upper end area of the guide pipe 45 via a corresponding mounting ring 52. The dial pointer 50 may also be placed with its mounting ring 52 loosely on the graduated dial 47, wherein it remains in this position because of gravity even with an axial adjustment of the telescopic rod 49 in the guide pipe 45.

The exact description of the function of this adjusting device 35 with its guide pipe 45, telescopic rod 49 as well as the two guide bars 27 and 28 can be taken from DE 41 21 938 A1, so that reference is made to the full contents of this publication at this point (DE 41 21 938 A1 is hereby incorporated by reference in its entirety).

Furthermore, it is apparent from FIG. 3 that a bearing head 53, in which another guide head 54 is rotatably mounted, which is embodied identical to the guide head 29 and is used for the displaceable mounting of the guide bar 28, is provided on the upper end of the telescopic rod 49.

In another variant not shown in the drawing, the telescopic rod 49 may also be accommodated in the guide pipe 45 in a nonrotatable but axially adjustable manner. In such an embodiment, the graduated dial and the dial pointer can be omitted. In such an embodiment, the angular position of the telescopic rod 49 corresponds to the 0° position shown in FIG. 3, so that consequently a forced angular alignment of the adjusting plate 1 and thus also of the upper spring plate 2 in relation to the bearing eye 37 is also brought about.

In the present exemplary embodiment of the adjusting plate 1 of FIGS. 1 and 3, the arrangement of the through holes 5, 8 and 10 and the arrangement of the holding section 16 are selected in such a way that, with correct angular alignment of the spring plate 2 meshing with the adjusting plate 1, the dial pointer 50 has a middle position in relation to the angle dial 48 of the graduated dial 47, which can be called, for example, a 0° position.

It is clear that an extremely simple angular alignment of the upper spring plate 2 can be achieved by means of using the adjusting plate 1, since the adjusting device 35 is always to be brought only into a 0° position, and thus, the installer does not have to have any knowledge about any amounts of angular settings for the correct angular alignment of the spring plate 2.

In this case, provisions are only made for the adjusting plate 1 to be able to be caused to mesh with the upper spring plate 2 in an exactly defined angular position. Furthermore, the holding plate 46 is to be embodied in relation to this angular position in such a way that the total alignment in a 0° position of the adjusting device 35 shown in FIG. 3 automatically brings about the correct angular alignment of the spring plate 2 in relation to the lower bearing eye 37. Since this bearing eye 37 is accommodated in the tensioning means 36 in a defined manner, a correct angular alignment of the spring plate 2 in relation to the lower bearing eye 37 is thus automatically brought about.

If the spring plate 2 shall be aligned in a mirror symmetrical manner with a plane of symmetry 56 running at right angles to the central longitudinal axis 55 of the bearing eye 37 for the present exemplary embodiment of the spring shock absorber leg 38, then the spring plate 2 with its centering pin 13 and its threaded holes 11 and 12, as is apparent from FIG. 2, is to be aligned in a simple manner with the other through holes 6, 7 and 9 provided. In this alignment, for example, the spring shock absorber leg 38 is to be installed on the right side of a motor vehicle, while the same spring shock absorber leg 38 is to be installed on the left side of a motor vehicle in the alignment shown in FIG. 3.

It can be recognized that an alignment of a spring plate 2 in relation to the bearing eye 37 of a spring shock absorber 38 can be carried out in an extremely simple and, above all, reliable manner by means of the adjusting plate 1 according to the present invention. Any knowledge about adjusting angle of the spring plate 2 in relation to the lower bearing eye 37 of the spring shock absorber leg 38 to be actually complied with is not necessary here for the installer. Furthermore, it can be easily imagined here that adjusting plates 1 of different shapes can be provided for different spring shock absorber legs, so that different, predetermined angular adjustments can also be made. Furthermore, an adjusting plate 1 with even more through holes may be provided, with which different upper spring plates 2 can be coupled in different angular positions. In this case, these additional through holes may be characterized accordingly. In this respect, the exemplary embodiment according to FIGS. 1 and 3 is shown only as an example for two angular positions of a spring plate. The present invention is not, however, limited to this simple embodiment.

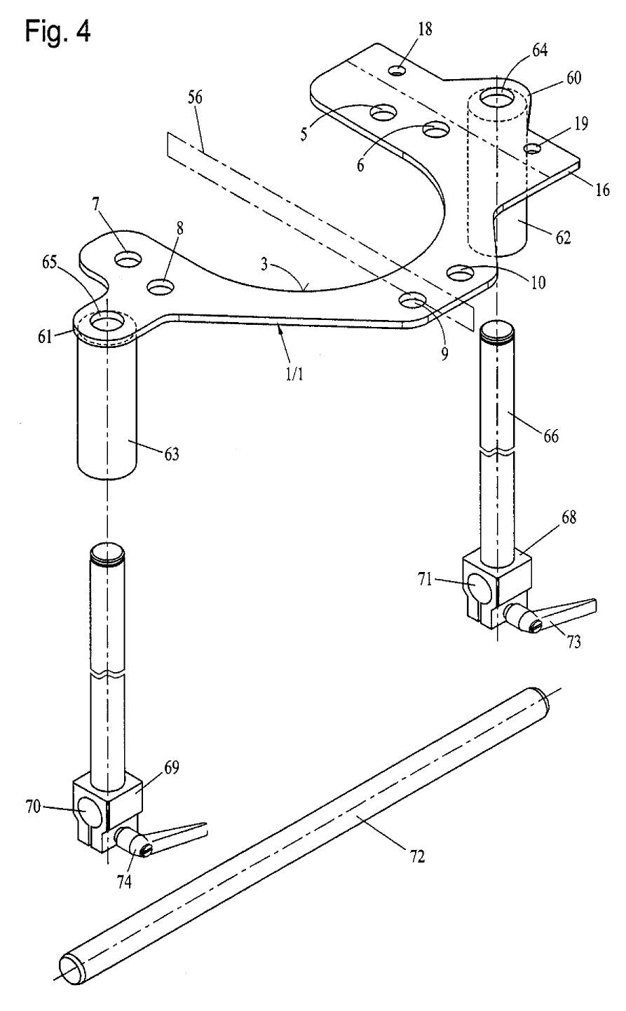

FIG. 4 shows another exemplary embodiment of an adjusting plate 1/1, the basic design of which essentially corresponds to the adjusting plate 1 of FIG. 1. Thus, the adjusting plate 1/1 also has a recess 3, which is used for accommodating an axially projecting mounting lug, as this is shown in FIG. 2 with the reference number 4 for the spring plate. Furthermore, the adjusting plate 1/1 is also provided with a plurality of through holes 5, 6, 7, 8, 9 and 10, the arrangement of which corresponds to the through holes 5 through 10 of the exemplary embodiment of the adjusting plate 1 of FIG. 1. Also in the adjusting plate 1/1, two other through holes 18 and 19 are provided in the area of the likewise present holding section 16, which can be used for coupling the adjusting plate 1/1 to the flat bar steel 26 of the aligning element 17 of FIG. 1. Thus, the adjusting plate 1/1 can be used in the same manner as described for the adjusting plate 1 of FIG. 3.

In addition, holding lugs 60 and 61, lying opposite the recess 3 in relation to the plane of symmetry 56, which project radially outwards in the present exemplary embodiment, are provided on the adjusting plate 1/1. On the underside, guide pipes 62 and 63, which can be welded to the adjusting plate 1/1 with their holding lugs 60 and 61, respectively, are arranged in a fixed manner at these holding lugs 60 and 61. These guide pipes 62 and 63 are arranged coaxially to guide holes 64 and 65 of the corresponding holding lugs 60 and 61, respectively, and are aligned at right angles to the adjusting plate 1/1.

These guide pipes 62 and 63 are used together with the guide holes 64 and 65 for the axially displaceable mounting of guides rods 66 and 67, on whose lower end a bearing head 68 and 69, respectively, is arranged in a fixed manner. These bearing heads 68, 69 are each provided with a cross hole 70 and 71, respectively, which are used for accommodating an aligning rod 72. This aligning rod 72 can be inserted into the two cross holes 70 and 71 during operation and can be locked in the cross holes 70 and 71 in a firmly seated manner by means of two tightening screws 73 and 74. The aligning rod 72 is used for aligning the adjusting plate 1/1 in relation to the bearing eye 37 of the spring shock absorber leg 38 of FIG. 3.

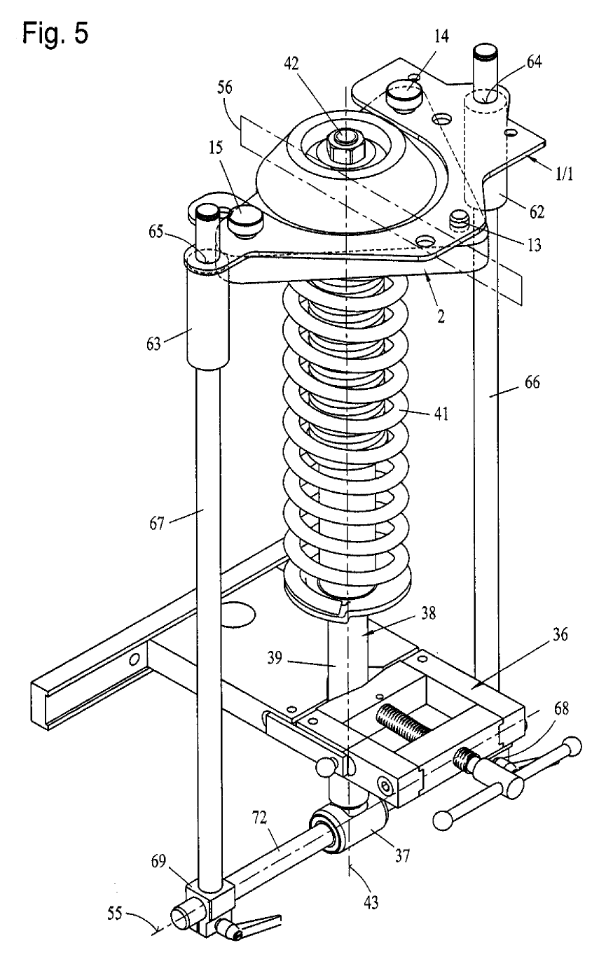

FIG. 5 shows a perspective view of such a mounted state of the entire device of FIG. 4. It can be recognized that the aligning rod 72 passes through the bearing eye 37 of the spring shock absorber leg 38 running transversely to the central longitudinal axis 43 of the spring shock absorber leg 38. This means that the aligning rod 72 runs (extends) coaxially to the central longitudinal axis 55 of the bearing eye 37. Furthermore, it can be recognized that the two guide rods 66, 67 with their two bearing heads 68 and 69 sit on the aligning rod 72 and are vertically aligned, and run approximately parallel to the central longitudinal axis 43 of the spring shock absorber leg 38.

With their upper end, the guide rods 66 and 67 pass through the respective guide pipe 62 and 63 together with the corresponding guide hole 64 and 65, respectively. Thus, the adjusting plate 1/1 is axially displaceably guided on the guide rods 66 and 67 via the guide pipes 62 and 63 arranged in a fixed manner on the underside. Because of this axial displaceability, the adjusting plate 1/1 can thus be placed onto the two guide rods 66 and 67 from above and can be caused to mesh with the spring plate 2, which can also be recognized from FIG. 5, as this was already shown in FIG. 3 for the exemplary embodiment according to the adjusting plate of FIG. 1.

Thus, the adjusting plate 1/1 is also in positive-locking connection with the centering pin 13 of the spring plate 2. Furthermore, the adjusting plate 1/1 is likewise mounted on the spring plate 2 in a firmly seated manner via the two fastening screws 14 and 15. Because of the selection of the arrangement of the through holes 5, 8 and 10 (see FIG. 4), the spring plate 2 can thus be mounted in a predetermined angular position on the adjusting plate 1/1, as this was already described in relation to the exemplary embodiment according to FIG. 3.

Because of the two guide pipes 62 and 63 and the guide rods 66 and 67 meshing with same, which are in turn connected to the aligning rod 72 with small clearance via their bearing heads 68 and 69, a precise alignment of the upper spring plate 2 in relation to the lower bearing eye 37 can be carried out, since the cross rod 72 is accommodated in the bearing eye 37 with small clearance. During the use, the guide rods 66 and 67 may be fixed in a fixed manner at the aligning rod 72 via the two bearing heads 68 and 69, so that an inadvertent change in angle is reliably ruled out, at least for the most part. The guide pipes 62 and 63 provided also prevent such an accidental change in angle, apart from the small clearance provided between the guide pipes 62 and 63 and the corresponding guide rods 66 and 67.

In the exemplary embodiment of the adjusting plate 1/1, the spring plate 2 can also be arranged in two different angular positions symmetrically to the plane of symmetry 56, as this was already described in relation to the exemplary embodiment according to FIG. 3.

It can be further recognized from FIG. 5 that the spring shock absorber leg 38 is clamped into the tensioning means 36 in a fixed manner with its guide pipe 39. To this end, the tensioning means 36 was correspondingly retrofitted, as this is known from the state of the art. Such clamping is helpful for the installer for the mounting procedure of the coil spring 41 and of the upper spring plate 2 but not absolutely necessary for the angular alignment of the upper spring plate 2.

According to the present invention, provisions are also made for the adjusting plate 1/1 to be able to have a plurality of diametrically opposite guide holes, with which the guide rods 66 and 67 can be caused to alternately mesh. Corresponding guide pipes, which, however, can be aligned upwards or downwards, alternately, may also be assigned to these guide holes, in order to be able to arrange the guide holes in the circumferential direction as close as possible to one another without the guide pipes colliding with one another. For the sake of clarity, such additional guide holes are not shown in FIG. 5. Thus, additional angular positions of a spring plate 2 arranged in a fixed manner on the adjusting plate 1/1 can be adjusted in relation to the lower bearing eye 37 via these additional guide holes with their additional guide pipes.

Groups of through holes in another angular position may also be provided in addition to the through holes 5 through 10, so that various spring plates 2 can be placed onto the coil spring 41 in different angular positions, depending on the present use conditions in relation to the bearing eye 37 and can be coupled to the piston rod 42 of the spring shock absorber leg 38.

The guide pipes shown in FIGS. 4 and 5 may also have a greater axial length and the guide rods may be embodied as axially shorter. Thus, the guide pipes together with the guide rods form a type of telescopic rod. By means of such an embodiment, the guide rods are prevented from projecting axially upwards over the adjusting plate during use.

While specific embodiments of the invention have been shown and described in detail to illustrate the application of the principles of the invention, it will be understood that the invention may be embodied otherwise without departing from such principles.

What is claimed is:

1. A device for adjusting a spring shock absorber leg, which has an upper spring plate and a lower spring plate arranged in an axially fixed manner at a shock absorber pipe of the spring shock absorber leg with a coil spring accommodated between the spring plates under pretension during operation, wherein said shock absorber pipe has, on its lower end, a bearing eye running transversely to said shock absorber pipe, the device comprising:
an adjusting plate caused adapted to mesh in a fixed manner with said upper spring plate in a predetermined angular position; and
an adjusting device, said adjusting plate together with said upper spring plate being alignable in relation to said lower bearing eye of said shock absorber pipe via said adjusting device.

2. A device in accordance with claim 1, wherein said adjusting plate has a plurality of through holes, via which said spring plate can be mounted in a fixed manner in the predetermined angular position at said adjusting plate.

3. A device in accordance with claim 2, wherein said adjusting plate has a plurality of groups of said through holes, via which said spring plate can be selectively mounted in different angular positions at said adjusting plate, and further comprising marks, said through holes being associated differently with said marks in groups for the various application purposes.

4. A device in accordance with claim 1, wherein said adjusting plate has a holding section, via which said adjusting plate can be coupled to said adjusting device.

5. A device in accordance with claim 1, wherein:
said adjusting device has a tensioning means for a fixed clamping of said bearing eye of said spring shock absorber leg, said tensioning means being provided with a holding plate, on which is arranged in a fixed manner a guide pipe running, during use, parallel to said spring shock absorber leg clamped with the bearing eye in said tensioning means, in which guide pipe a telescopic rod is accommodated in an axially displaceable manner; and
an aligning element is provided in the upper end area of said telescopic rod, said adjusting plate being fastened to said aligning element in a detachable manner with a holding section.

6. A device in accordance with claim 5, wherein:
a graduated dial is provided on an upper end of said guide pipe with an angle dial that is connected to said guide pipe in a fixed manner; and
a dial pointer is connected to said telescopic rod in a manner adapted to rotate in unison therewith, said dial pointer being arranged in an area of said angle dial; and
said telescopic rod is rotatable in relation to said guide pipe.

7. A device in accordance with claim 5, wherein
said aligning element has a first cylindrical guide bar, by means of which said aligning element is mounted axially displaceably and rotatably in a guide head, which is arranged in a fixed manner in an end area of a second guide bar, and
said second guide bar extends at right angles to said first guide bar;
said second guide bar is mounted axially adjustably and rotatably at the upper end of said telescopic rod in another said guide head; and
said another guide head is mounted pivotably via a bearing head at the upper end of said telescopic rod at right angles to said central longitudinal axis of said telescopic rod.

8. A device in accordance with claim 1, wherein
said adjusting device is formed from two guide pipes, two guide rods and an aligning rod;
said guide pipes are arranged in a fixed manner in the area of two holding lugs of said adjusting plate, and
said aligning rod can be caused to mesh with the bearing eye of the spring shock absorber leg with small clearance and can be brought into connection, in a manner adapted to rotate in unison and in an axially adjustably manner, with said guide pipes of said adjusting plate via the two said guide rods.
